(19) United States
(12) Patent Application Publication
(10) Pub. No.: US 2012/0072657 A1
(43) Pub. Date: Mar. 22, 2012

(54) SYSTEM AND METHOD TO WRITE DATA USING PHASE-CHANGE RAM

(75) Inventors: Chul LEE, Suwon-si (KR); Joo Young Hwang, Suwon-si (KR); Min Chan Kim, Suwon-si (KR)

(73) Assignee: Samsung Electronics Co., Ltd, Suwon-si (KR)

(21) Appl. No.: 13/233,486

(22) Filed: Sep. 15, 2011

(30) Foreign Application Priority Data
Sep. 16, 2010 (KR) 10-2010-0091209

(51) Int. Cl. G06F 12/00

(52) U.S. Cl. 711/104; 711/E12.001

(57) ABSTRACT

A data recording system includes a file system configured to manage block-based input/output of data, a phase-change random access memory (PRAM) configured to write first data among the data in units of sub blocks, and a block abstract layer configured to receive a write command of the first data to a first particular block in the PRAM from the file system and log changed data information to a second particular block in the PRAM in units of sub blocks, and a method to provide the same.

### CROSS-REFERENCE TO RELATED APPLICATIONS

This application claims priority under 35 U.S.C. §119(a) from Korean Patent Application No. 10-2010-0091209 filed on Sep. 16, 2010, the disclosure of which is hereby incorporated by reference in its entirety.

### BACKGROUND OF THE INVENTION

1. Field of the Invention

The present inventive concept relates to a system and method to write data using phase-change random access memory (PRAM), and more particularly, to a system and method to write data using a PRAM in a block-based input/output device.

2. Description of the Related Art

Digital devices, such as digital cameras, MP3 players, hand-held phones, and personal digital assistants (PDAs), use a block storage device which can store a large amount of data.

The block storage device is a storage medium which transmits or receives data in units of blocks like a flash memory and a hard disk. Since the block storage device uses block-based transmission, a medium like a dynamic random access memory (DRAM) in which a central processing unit (CPU) can access in units of bytes is necessary for data transmission between the block storage device and the CPU.

Recently, with the development of a non-volatile RAM, there have been some efforts to use the non-volatile RAM instead of the block storage device. Data recording systems using a non-volatile RAM as a block storage device requires a data writing method which supports block atomicity and increases performance as well.

### SUMMARY OF THE INVENTION

Some embodiments of the present inventive concept provide a system and method to write data using a non-volatile random access memory (RAM) to increase system performance and to keep the consistency of a system by supporting block atomicity.

Additional features and utilities of the present general inventive concept will be set forth in part in the description which follows and, in part, will be obvious from the description, or may be learned by practice of the general inventive concept.

According to some embodiments of the present inventive concept, there is provided a data recording system including a fine system configured to manage block-based input/output of data, a phase-change random access memory (PRAM) configured to write first data among the data in units of sub blocks, and a block abstract layer configured to receive a write command of the first data to a first particular block in the PRAM from the file system and log changed data information to a second particular block in the PRAM in units of sub blocks.

The changed data information may correspond to a difference between the first data and a second data that has been stored in the first particular block.

The second particular block may be a log block.

The block abstract layer may record the changed data information logged to the log block in the first particular block when the log block is deficient in spare space.

The block abstract layer may determine whether the change data information occupies more than a predetermined percentage of the first particular block and log the changed data information to the second particular block in the PRAM in units of sub blocks when it is determined that the change data information does not occupy more than the predetermined percentage of the first particular block.

Changed data information that has been logged to the log block may include a log start tag and a log end tag.

According to other embodiments of the present inventive concept, there is provided a data recording system including a fine system configured to manage block-based input/output of data, a PRAM configured to write first data among the data in units of sub blocks, and a block abstract layer configured to receive a write command of the first data to a first particular block in the PRAM from the file system, log data of the first particular block to a second particular block in the PRAM, and record changed data information in the first particular block in the PRAM in units of sub blocks.

Data of the first particular block that has been logged to the log block may include a log start tag and a log end tag.

After the changed data information is recorded in units of sub blocks in the first particular block in the PRAM, the block abstract layer may record success or failure of the recording in the log end tag.

The block abstract layer may determine whether the change data information occupies more than a predetermined percentage of the first particular block, and when it is determined that the change data information does not occupy more than the predetermined percentage of the first particular block, the block abstract layer may log the data of the first particular block to the second particular block in the PRAM and record the changed data information in units of sub blocks in the first particular block in the PRAM.

The PRAM may write the first data in units of blocks or sub blocks and the block abstract layer may determine whether the change data information occupies more than the predetermined percentage of the first particular block, and when it is determined that the change data information occupies more than the predetermined percentage of the first particular block, the block abstract layer may receive the write command of the first data to the first particular block in the PRAM from the file system and record the changed data information in units of blocks in the second particular block in the PRAM.

According to other embodiments of the present inventive concept, there is provided a data recording system, including a phase-change random access memory (PRAM) configured to store portions of data among block-based data in units of sub blocks; and a block abstract layer configured to receive write commands from a file system to write the portions of data to a particular block and to log only changed data information to a log block in the PRAM in units of sub blocks.

In an embodiment, the data recording system further includes a file system configured to manage block-based input/output of data.

In an embodiment, the changed data information corresponds to a difference between the portions of data to be written and data that has been previously stored in the particular block.

In an embodiment, the block abstract layer records the changed data information logged to the log block in the particular block when the log block is deficient in spare space.

According to other embodiments of the present inventive concept, there is provided a method of recording data in a recording system, including: receiving a write command from a file system to write first data among block-based data in a phase-change random access memory (PRAM) in units of sub blocks; and writing the first data to a first particular block in the PRAM and to log changed data information to a second particular block in the PRAM in units of sub blocks.

In an embodiment, the changed data information corresponds to a difference between the first data and a second data that has been stored in the first particular block.

In an embodiment, the second particular block may be a log block.

In an embodiment, the changed data information logged to the log block is recorded in the first particular block when the log block is deficient in spare space.

According to other embodiments of the present inventive concept, there is provided a method of recording data in a recording system, including: receiving a write command from a file system to write first data among block-based data in a phase-change random access memory (PRAM) in units of sub blocks; and writing the first data to a first particular block in the PRAM and to log data of the first particular block to a second particular block in the PRAM, and recording changed data information in the first particular block in the PRAM in units of sub blocks.

In an embodiment, the changed data information corresponds to a difference between the first data and a second data that has been stored in the first particular block.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 is a diagram of a data recording system according to some embodiments of the present inventive concept;

FIG. 2 is a diagram explaining a comparison example of a method of writing data;

FIG. 3 is a diagram explaining a method writing data according to some embodiments of the present inventive concept;

FIG. 4 is a diagram explaining a method of writing data according to other embodiments of the present inventive concept;

FIG. 5 is a diagram showing blocks in a non-volatile random access memory (NVRAM) according to some embodiments of the present inventive concept;

FIG. 6A is a diagram showing sub blocks in a first block illustrated in FIG. 5;

FIG. 6B is a mapping table in a data recording system using phase-change random access memory (PRAM) according to some embodiments of the present inventive concept;

FIG. 7 is a diagram explaining a log structure according to some embodiments of the present inventive concept;

FIG. 8 is a diagram explaining a method writing data according to further embodiments of the present inventive concept; and

FIG. 9 is a flowchart of a data recording method according to some embodiments of the present inventive concept.

### DETAILED DESCRIPTION OF THE PREFERRED EMBODIMENTS

The present inventive concept will now be described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

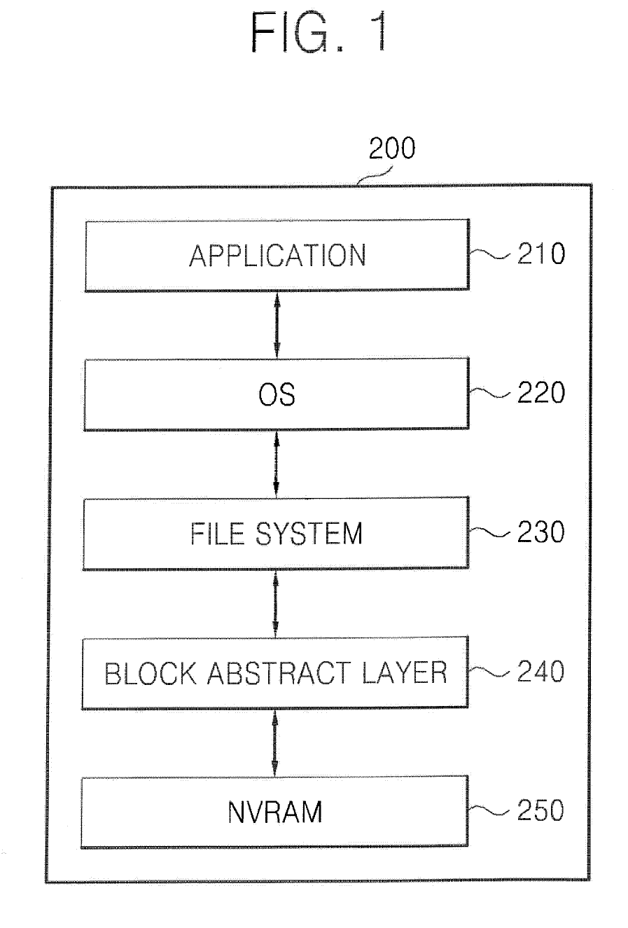

FIG. 1 is a diagram of a data recording system 200 according to some embodiments of the present inventive concept. The data recording system 200 includes an application 210, an operating system (OS) 220, a file system 230, a block abstract layer 240, and a non-volatile random access memory (NVRAM) 250.

The application 210 executes a general user program driven by the OS 220. For instance, the application 210 may include a variety of applications such as an application for playing MP3 files, an application for playing video files, an application for playing games, and a content search application.

The OS 220 manages a set of programs, which runs the file system 230 and provides an interface so that users can easily use hardware. The OS 220 manages resources such as a processor, a memory device, an input/output device, a communication device, and data,

The file system 230 provides methods and functions of writing, reading and using data. The file system 230 performs functions to provide efficient management of a set of data, i.e., a file and provides quick data search, recovery, and support of mass data.

The file system 230 may reduce a bottleneck phenomenon brought to a system by a storage medium, which has a lower processing speed than a processor such as a central processing unit (CPU), and allows a file to be processed smoothly, thereby increasing the entire system performance.

The file system 230 performs data input/output in units of blocks consisting of a plurality of bytes. Here, a block is a unit of input/output data in the file system 230. For instance, the block may be 512 bytes or a multiple of 512 bytes in size. However, the size of the block is not limited to a certain number of bytes like 512 or 128. A set of a plurality of byte units which may be changed by those of ordinary skill in the art may be referred to as a block. The block may be used as another term indicating a unit of input/output data such as a cluster, a sector, or a page.

The block abstract layer 240 functions as an intermediary so that the file system 230 performs a write operation on the NVRAM 250. The block abstract layer 240 performs a write operation on the NVRAM 250 in units of sub blocks smaller than blocks in size. Here, a sub block indicates a unit of data size which is relatively smaller than the data size of a block and is a decreasing multiple of the size of the block. For instance, when the block is 1024 bytes in size, the sub block is 512, 256, . . . , or 1 byte in size.

The NVRAM 250 may be an electrically erasable programmable read-only memory (EEPROM), a flash memory, a magnetic RAM (MRAM), a spin-transfer torque MRAM, a ferroelectric RAM (FRAM), a phase-change RAM (PRAM), a resistive RAM (RRAM), nanotube RRAM, a polymer RAM, a nano floating gate memory, a holographic memory, a molecular electronic memory device, or an insulator resistance change memory.

In particular, the NVRAM 250 may be a PRAM. The PRAM is also known as PCM or PCRAM and has both an advantage of flash memory retaining the stored information even when not powered on and an advantage of a DRAM having a fast processing speed, However, the PRAM has a writing speed slower than a reading speed and may thus slow down in a write operation.

The file system 230 supporting block-based input/output usually performs a write operation in units of blocks. Accordingly, even when only part of data in a block is changed, the entire block needs to be written again. Since the NVRAM 250 and particularly the PRAM is slower in a write operation than in a read operation, the writing of the entire block may remarkably decrease the speed of the entire system 200.

To prevent the decrease of the speed of the entire system 200, the block abstract layer 240 is used to allow the file system 230, which performs input/output in block units, to write only the changed data to the NVRAM 250, i.e., a PRAM storing data. The block abstract layer 240 may receive a write command on a particular block from the file system 230 and enable a write operation to be performed in units of sub blocks on only the changed part of the block in the NVRAM 250, i.e., a PRAM. In other words, the block abstract layer 240 may enable a write operation to be performed on only a portion of data in a block.

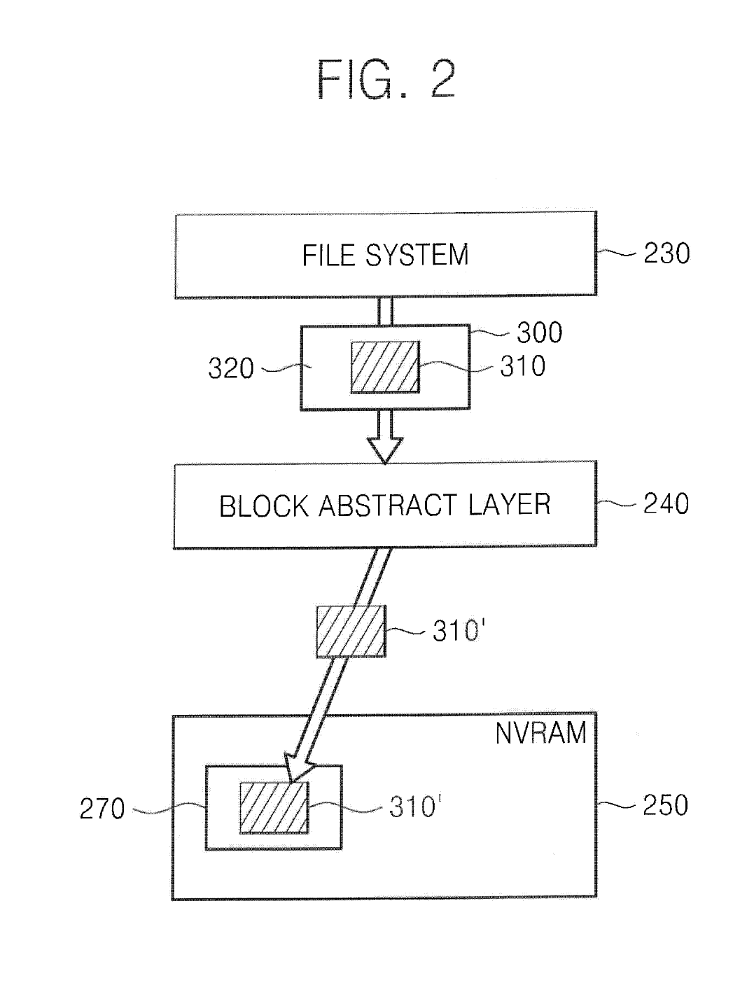

FIG. 2 is a diagram explaining a comparison example of a method of writing data. Referring to FIG. 2, the file system 230 transmits change block information 300 to the block abstract layer 240. The change block information 300 includes changed data information 310 and unchanged data information 320.

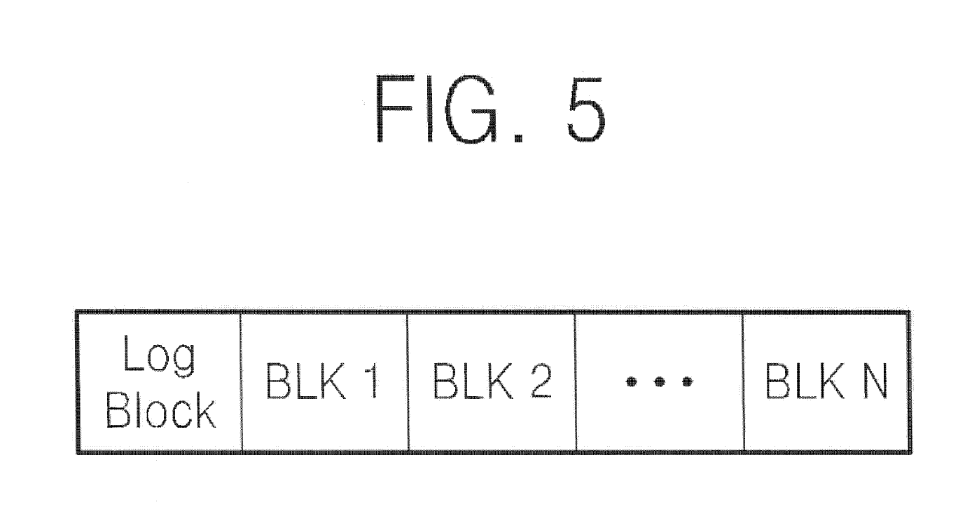

The block abstract layer 240 intermediates between the file system 230 and the NVRAM 250 so that the file system 230 performs a write operation on the NVRAM 250. The block abstract layer 240 writes only the changed data information 310 to a unique block 270 in the NVRAM 250 in a form of sub block 310′. For instance, only the changed part of a block corresponding to the change block information 310 is written in bytes to the unique block 270 in the NVRAM 250 in a form of a sub block. The unique block 270 may be one of first through N-th blocks BLK1 through BLKN shown in FIG. 5.

This method reduces a write response time by preventing an unnecessary write operation from being performed in the NVRAM 250, but has a problem in terms of maintaining the consistency of a data recording system since it does not support block atomicity.

Another comparison example of a method of writing data is disclosed in Korean Patent Publication No. 10-2008-0112069. The method disclosed in Korean Patent Publication No. 10-2008-0112069 supports block atomicity but is disadvantageous in that an unnecessary write operation occurs since the entire data of a block is written to NVRAM, and as a result, performance is decreased.

Accordingly, a method of writing data, by which block atomicity is supported and performance is increased, is desired.

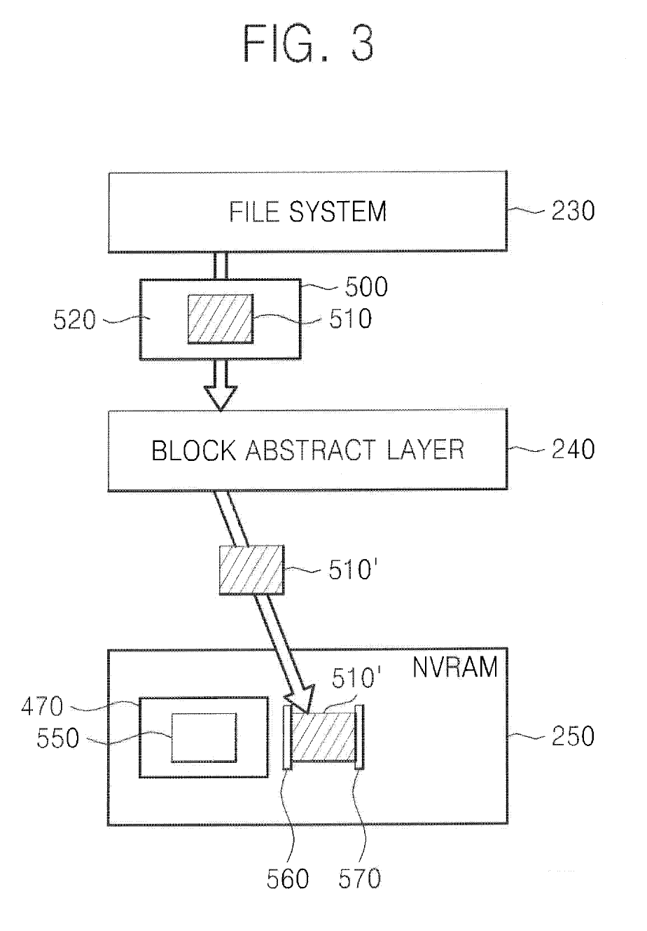

FIG. 3 is a diagram explaining a method of writing data according to some embodiments of the present inventive concept. Referring to FIG. 3, the file system 230 transmits change block information 500 to the block abstract layer 240. The change block information 500 includes changed data information 510 and unchanged data information 520. The changed data information 510 may indicate information corresponding to a difference in comparison between the change block information 500 and information stored in a unique block 470 of the NVRAM 250. The unchanged data information 520 may indicate information corresponding to the same part in comparison between the change block information 500 and the information stored in the unique block 470.

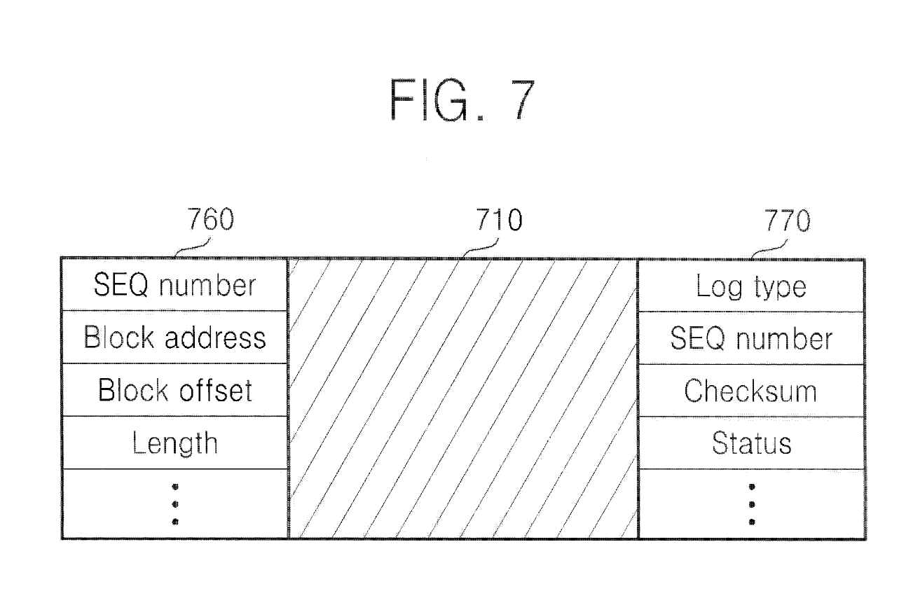

The block abstract layer 240 intermediates between the file system 230 and the NVRAM 250 so that the file system 230 performs a write operation on the NVRAM 250. The block abstract layer 240 logs only the changed data information 510 within the change block information 500 to a log block (shown in FIG. 5), not a unique block 470, in the NVRAM 250 and in a form of sub block 510′. In the logging procedure, a log start tag 560 is recorded, then the data of the sub block 510′ is recorded, and finally a log end tag 570 is recorded. The structure of the log block will be described with reference to FIG. 7 later. Thereafter, when the log block is deficient in spare space due to continuous logging, the data of the sub block 510′ is recorded in a particular region 550 in the unique block 470, and whether the data of the sub block 510′ has been recorded is recorded in the log end tag 570. For instance, whether the data of the sub block 510′ has been recorded may be recorded in a status field in a log end tag 730 illustrated in FIG. 7.

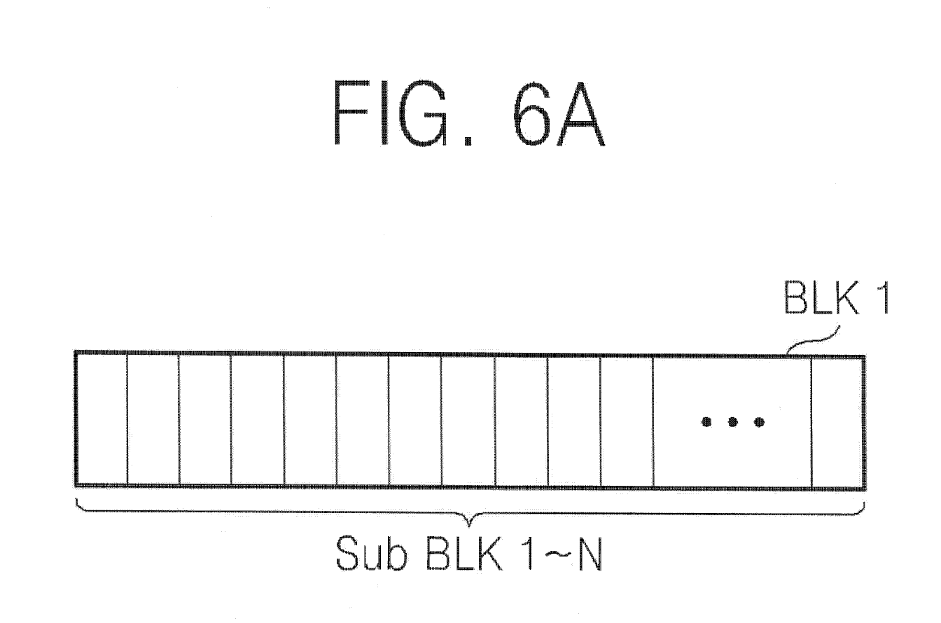

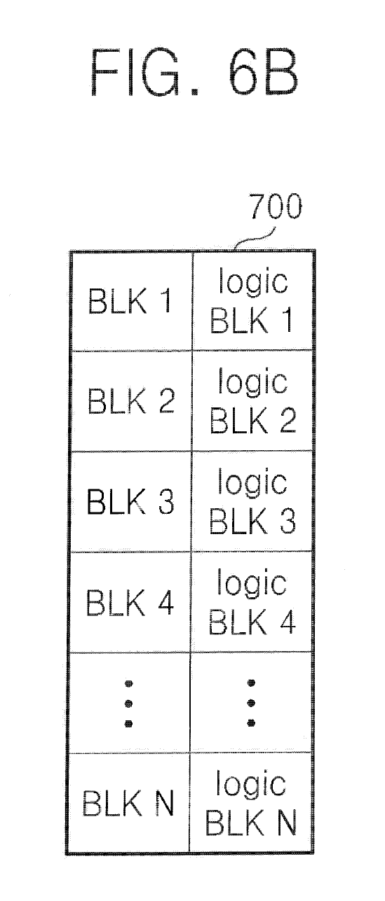

The unique block 470 may be one of the first through N-th blocks BLK 1 through BLK N shown in FIG. 5 and the particular region may be one of first through N-th sub blocks Sub BLK 1 through Sub BLK N illustrated in FIG. 6A. For instance, when data is recovered after power to a data recording system is interrupted, the log block shown in FIG. 5 is read and the data of the sub block 510′ defined by the log start tag 560 and the log end tag 570 is recognized. Whether the data of the sub block 510′ has been recorded in the particular region 550 in the unique block 470, which is recorded in the log end tag 570, is checked and unrecorded data is recorded in the unique block 470. Once all of the unrecorded data is recorded, the log block shown in FIG. 5 is invalidated.

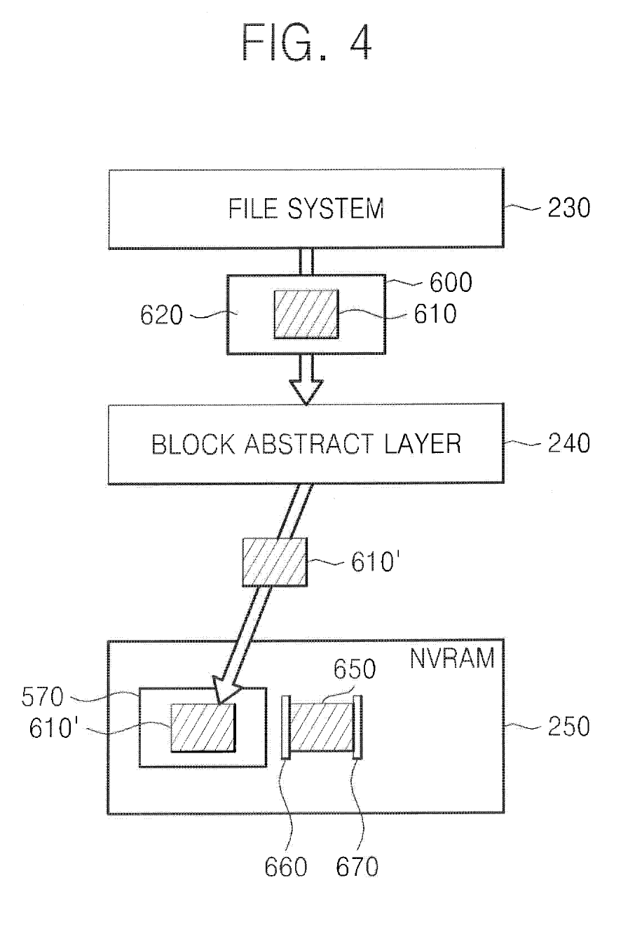

FIG. 4 is a diagram explaining a method of writing data according to other embodiments of the present inventive concept. Referring to FIG. 4, the file system 230 transmits change block information 600 to the block abstract layer 240. The change block information 600 includes changed data information 610 and unchanged data information 620.

The block abstract layer 240 intermediates between the file system 230 and the NVRAM 250 so that the file system 230 performs a write operation on the NVRAM 250. The block abstract layer 240 logs only the changed data information 610 within the change block information 600 to a unique block 570 in the NVRAM 250 in a form of a sub block 610′. Before the information of the sub block 610′ is logged to a particular region in the unique block 570, data in the particular region (referred to as particular region data) in the unique block 570 is logged to the log block shown in FIG. 5. The particular region data is logged to the log block by recording a log start tag 660, recording particular region data 650, and finally recording a log end tag 670. After the particular region data 650 is logged to the log block shown in FIG. 5, the information of the sub block 610′ is written over to the particular region in the unique block 570 and then success or failure of the overwriting is recorded in the log end tag 670.

For instance, when data is recovered after power to a data recording system is interrupted, the log block shown in FIG. 5 is read and the particular region data 650 defined by the log start tag 660 and the log end tag 670 is recognized. Success or failure of the overwriting, which is recorded in the log end tag 670, is checked. When the overwriting has failed, the particular region data 650 is returned to an original position in the log block shown in FIG. 5. Once all of the procedure ends, the log block shown in FIG. 5 is invalidated.

FIG. 5 is a diagram showing blocks in the NVRAM 250 according to some embodiments of the present inventive concept. FIG. 6A is a diagram showing the sub blocks Sub BLK 1 through Sub BLK N in the first block BLK 1 illustrated in FIG. 5. Referring to FIGS. 5 and 6A, the NVRAM 250 includes the log block and the first through N-th blocks BLK 1 through BLK N. Each of the first through N-th blocks BLK1 through BLKN includes a plurality of sub blocks.

FIG. 6A shows the first block BLK 1 as a representative of the first through N-th blocks BLK 1 through BLK N. The first block BLK 1 includes the first through N-th sub blocks Sub BLK 1 through Sub BLK N. For instance, each of the first through N-th blocks BLK 1 through BLK N may include the first through N-th sub blocks Sub BLK 1 through Sub BLK N, and sub block byte information may be stored in at least one sub block among the first through N-th sub blocks Sub BLK 1 through Sub BLK N.

FIG. 6B is a mapping table 700 in a data recording system using a PRAM according to some embodiments of the present inventive concept. The PRAM is formatted in block units the same as the unit of input/output of the file system 230. The PRAM is physically initialized to a plurality of blocks and may include, for example, the first through N-th blocks BLK 1 through BLK N in the order as shown in FIG. 5.

Each of the blocks (e.g., the first through N-th blocks BLK1 through BLKN) of the PRAM may be accessed based on the mapping table 700 including mapping information. The mapping table 700 includes a block address of the PRAM corresponding to a logic block of the file system 230. For instance, the mapping table 700 may include a list of addresses of the first block BLK 1 corresponding to a first logic block logic BLK 1, the second block BLK 2 corresponding to a second logic block logic BLK 2, the third block BLK 3 corresponding to a third logic block logic BLK 3, the fourth block BLK 4 corresponding to a fourth logic block logic BLK 4, and the N-th block BLK N corresponding to an N-th logic block logic BLK N.

Accordingly, mapping information may be provided to the file system 230 or the block abstract layer 240, and the file system 230 or the block abstract layer 240 may access the blocks of the PRAM by using the mapping table 700.

FIG. 7 is a diagram explaining the log structure described in FIGS. 3 and 4. The log structure includes a log start tag 760, a data region 710, and a log end tag 770,

The log start tag 760 indicates the start of a log and may include information such as a sequence (SEQ) number, a block address, a block offset, and length of the log.

The data region 710 is a region in which data is recorded. The log end tag 770 indicates that recording is completed and may include a log type, a SEQ number, a checksum, and a status field indicating the status of the log which includes validity or invalidity of the log.

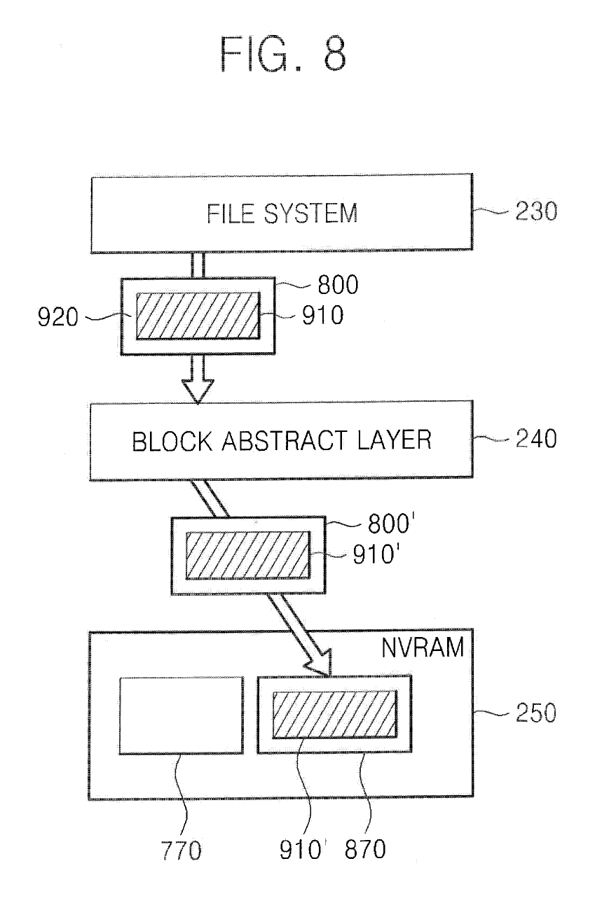

FIG. 8 is a diagram explaining a method of writing data according to further embodiments of the present inventive concept. The method illustrated in FIG. 8 is for a case where changed data information is large. Referring to FIG. 8, the file system 230 transmits change block information 800 to the block abstract layer 240. The change block information 800 includes changed data information 910 and unchanged data information 920. At this time, the changed data information 910 occupies the greater part (e.g., more than a predetermined percentage) of the change block information 800. When the greater part of the change block information 800 is the changed data information 910, the overhead of a log start tag and a log end tag may be increased, and data is written using the method illustrated in FIG. 2.

In detail, the block abstract layer 240 writes change block information 800′ including changed data information 910′ to a shadow block 870, not a unique block 770, in the NVRAM 250.

The unique block 770 may be one of the first through N-th blocks BLK 1 through BLK N shown in FIG. 5. The shadow block 870 may be the log block or one of the first through N-th blocks BLK 1 through BLK N shown in FIG. 5.

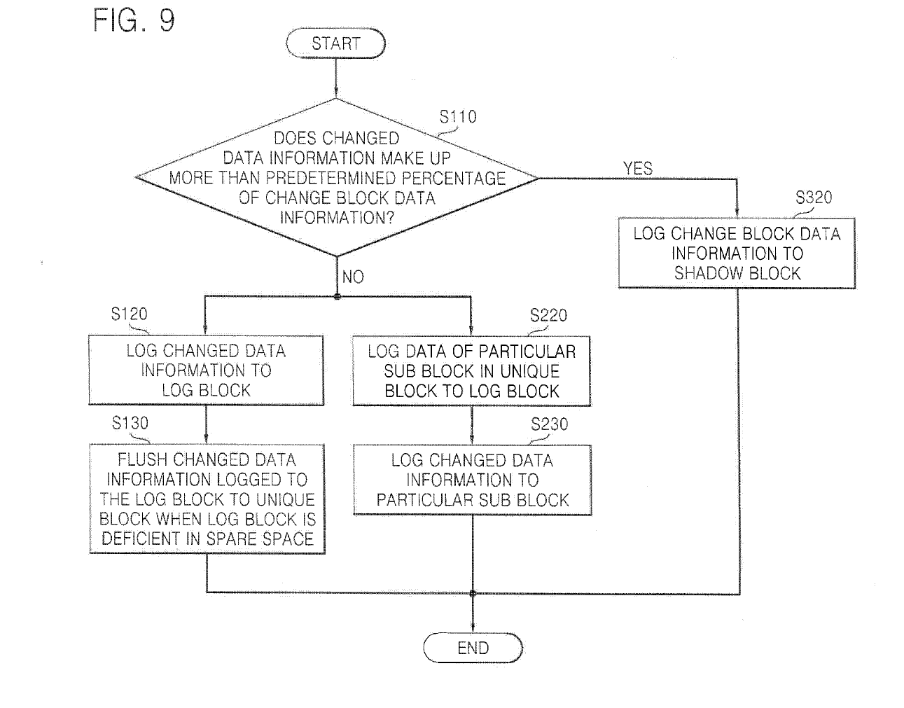

FIG. 9 is a flowchart of a data recording method according to some embodiments of the present inventive concept. The data recording method may be performed by the data recording system 200 illustrated in FIG. 1 and includes the methods described in FIGS. 3, 4, and 8.

Referring to FIGS. 1 and 9, it is determined whether changed data information makes up more than a predetermined percentage of change block data information in operation S110. When it is determined that the changed data information does not make up more than the predetermined percentage of the change block data information, a first flow, i.e., operations S120 and S130 or a second flow, i.e., operations S220 and S230 is performed. At this time, changed data may be detected by reading second data from a first particular block in NVRAM 250 in units of blocks and comparing the second data with first data. The first data corresponds to data which is indicated to write to the first particular block in NVRAM 250 from a file system 230.

In the first flow, the changed data information is logged to a log block in operation S120. When the log block is deficient in spare space, the changed data information logged to the log block is flushed to a unique block (e.g., one of the first through N-th blocks BLK 1 through BLK N shown in FIG. 5) in operation S130. The logging procedure may be performed by sequentially recording a log start tag, sub block data, and a log end tag. When the log block (shown in FIG. 5) is deficient in spare space due to continuous logging, the sub block data is recorded in a particular region (e.g., a particular sub block) within the unique block, and whether the sub block data has been recorded is recorded in the log end tag.

In the second flow, data of a particular sub block in the unique block is logged to the log block (shown in FIG. 5) in operation S220. The changed data information is logged to the particular sub block in operation S230. The procedure for logging the data of the particular sub block to the log block is performed by sequentially recording a log start tag, the data of the particular sub block, and a log end tag. After the data of the particular sub block is logged to the log block, the changed data information is written over to the unique block and success or failure of the overwriting is recorded in the log end tag.

When it is determined that the changed data information makes up more than the predetermined percentage of the change block data information, the change block data information is logged to a shadow block in operation S320. The shadow block may be the log block or one of the first through N-th blocks BLK 1 through BLK N shown in FIG. 5.

As described above, according to some embodiments of the present inventive concept, speed of data writing to NVRAM is increased, thereby increasing the performance of a data recording system using the NVRAM. In addition, block atomicity is supported, so that the consistency of the system is maintained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A data recording system comprising:
a file system configured to manage block-based input/output of data;
a phase-change random access memory (PRAM) configured to write first data among the data in units of sub blocks; and
a block abstract layer configured to receive a write command of the first data to a first particular block in the PRAM from the file system and log changed data information to a second particular block in the PRAM in units of sub blocks.

2. The data recording system of claim 1, wherein the changed data information corresponds to a difference between the first data and a second data that has been stored in the first particular block.

3. The data recording system of claim 1, wherein the second particular block is a log block.

4. The data recording system of claim 1, wherein the block abstract layer records the changed data information logged to the second particular block in the first particular block when the second particular block is deficient in spare space.

5. The data recording system of claim 1, wherein the block abstract layer determines whether the changed data information occupies more than a predetermined percentage of the first particular block and logs the changed data information to the second particular block in the PRAM in units of sub blocks when it is determined that the changed data information does not occupy more than the predetermined percentage of the first particular block.

6. The data recording system of claim 1, wherein the changed data information that has been logged to the log block comprises a log start tag and a log end tag.

7. A data recording system comprising:
a file system configured to manage block-based input/output of data;
a phase-change random access memory (PRAM) configured to write first data among the data in units of sub blocks; and
a block abstract layer configured to receive a write command of the first data to a first particular block in the PRAM from the file system, log data of the first particular block to a second particular block in the PRAM, and record changed data information in the first particular block in the PRAM in units of sub blocks.

8. The data recording system of claim 7, wherein the changed data information corresponds to a difference between the first data and a second data that has been stored in the first particular block.

9. The data recording system of claim 7, wherein the second particular block is a log block.

10. The data recording system of claim 9, wherein the data of the first particular block that has been logged to the log block comprises a log start tag and a log end tag.

11. The data recording system of claim 10, wherein after the changed data information is recorded in units of sub blocks in the first particular block in the PRAM, the block abstract layer records success or failure of the recording in the log end tag.

12. The data recording system of claim 7, wherein the block abstract layer determines whether the changed data information occupies more than a predetermined percentage of the first particular block, logs the data of the first particular block to the second particular block in the PRAM and records the changed data information in units of sub blocks in the first particular block in the PRAM when it is determined that the change data information does not occupy more than the predetermined percentage of the first particular block.

13. The data recording system of claim 7, wherein the PRAM writes the first data in units of blocks or sub blocks.

14. The data recording system of claim 13, wherein the block abstract layer determines whether the change data information occupies more than a predetermined percentage of the first particular block, and receives the write command of the first data to the first particular block in the PRAM from the file system and records the changed data information in units of blocks in the second particular block in the PRAM when it is determined that the changed data information occupies more than the predetermined percentage of the first particular block.

15. The data recording system of claim 14, wherein the second particular block is a log block.

16. A method of recording data in a recording system, comprising:
receiving a write command from a file system to write first data among block-based data in a phase-change random access memory (PRAM) in units of sub blocks; and
writing the first data to a first particular block in the PRAM and to log changed data information to a second particular block in the PRAM in units of sub blocks.

17. The method of claim 16, wherein the changed data information corresponds to a difference between the first data and a second data that has been stored in the first particular block.

18. The method of claim 17, wherein the second particular block is a log block.

19. The method of claim 18, wherein the changed data information logged to the log block is recorded in the first particular block when the log block is deficient in spare space.
